(19) United States
(12) Patent Application Publication
(10) Pub. No.: US 2012/0039494 A1
(43) Pub. Date: Feb. 16, 2012

(54) Loudspeakers

(75) Inventor: Christien Ellis, Hertfordshire (GB)

(73) Assignee: HiWave Technologies (UK) Limited, Cambourne, Cambridgeshire (GB)

(21) Appl. No.: 13/202,888

(22) PCT Filed: Feb. 16, 2010
(86) PCT No.: PCT/GB2010/000271

§ 371 Date: Nov. 1, 2011

(30) Foreign Application Priority Data
Feb. 24, 2009 (GB) 0903033.9

(51) Int. Cl. H04R 1/00

(52) U.S. Cl. 381/166

(57) ABSTRACT

The invention relates to a drive unit for a loudspeaker, and a loudspeaker including the same. The drive unit includes a magnet assembly which defines primary and secondary gaps with respect to which a voice coil assembly is movable and in which the same is mounted. The voice coil assembly includes a former which is located and suspended in the secondary gap by ferrofluid provided in said secondary gap, to locate the voice coil assembly without the need for a spider or other mechanical locating means to be provided.

The invention relates to improvements to Loudspeakers, in particular to the moving coil assemblies provided, and more particularly, but not exclusively, to moving coil motors such as those which are used to drive the diaphragms of loudspeaker drive units, and to drive units and loudspeakers incorporating such moving coil assemblies.

As is known, such moving coil assemblies include a magnet assembly which defines an annular gap and a coil assembly is arranged in the annular gap so as to be axially and reciprocally movable therein in response to an alternating electrical signal which is applied to the coil assembly. Such coil assemblies are commonly known as “voice coils”.

A form of drive unit known as excursion pistonic diaphragm loudspeaker drive units, e.g. cone-type loudspeaker drive units, normally comprise a chassis which supports the magnet assembly of the motor and a conical diaphragm, which is drivingly coupled to the coil assembly. The conical diaphragm is usually supported on two flexible suspension elements to ensure that it moves in a linear fashion. These are known as the “surround” and the “spider” respectively, the surround being attached between the outer periphery of the diaphragm and the chassis and the spider being attached between the inner periphery of the diaphragm and the chassis. Since the inner periphery of the diaphragm is coupled to the voice coil, the spider can alternatively be connected between the voice coil former and the chassis. The two suspension elements are normally spaced apart axially as far as is possible to increase the stability of the coil assembly in the annular gap. For large excursions, both the surround and the spider are required to extend linearly over the majority of the maximum excursion of the driver. Typically large roll-surrounds and large diameter spiders are generally employed to achieve this in larger drive units. Smaller size excursion drive units, e.g. so-called tweeters, often use a single suspension element for the diaphragm and voice coil. This single suspension can be formed by a continuation of the outer periphery of the diaphragm material as one or more corrugations. This is typically done in dome-shaped drive units.

However, problems are experienced in the design of small, high excursion drivers due to the lack of available space in the unit in which to accommodate the suspension. The inclusion of a spider design presents an even more difficult problem because of the lack of space. In these smaller drive units, large excursion spiders cannot be accommodated, and as a result, the linearity and excursion of the drive unit is often compromised. However, conventionally removal of the spider altogether is not practically possible, even if it is possible to achieve static centration of the voice coil. This is due to the possibility of rocking modes in the diaphragm in the operating bandwidth of the drive unit which cause instability of the voice coil in the gap of the magnet assembly.

It is has been previously proposed to use a single suspension full range loudspeaker drive unit having a rectangular high aspect-ratio flat diaphragm, with the diaphragm operating both in piston mode and in bending and with a single centrally placed exciter. Such a design, using only a surround suspension and no spider suspension, requires a relatively large voice coil gap in the magnet assembly to accommodate the lateral displacement of the voice coil in use due to rocking modes in the diaphragm. Thus the motor efficiency is compromised in the interests of reliability.

In United States patent application publication US2007/0189572 A1 there is disclosed a musical instrument loudspeaker system comprising; a cabinet; at least a planar magnetic driver for mid and high frequency sound signals mounted in the cabinet; and at least one conical voice coil driver for low frequency mounted in the cabinet. In this case the conical voice coil driver comprises; a voice coil; a magnet; a cone; and a ferrofluid interposed between said voice coil and said magnet, said ferrofluid constituting an alignment means for aligning said voice coil with said magnet.

However, there are significant problems associated with the use of ferrofluid in the gaps of high excursion moving coil systems of large loudspeaker drive units, not least due to the tendency of droplets of the ferrofluid to be flung from the gap during operation of the drive unit. It is believed that this may arise as a result of drag or turbulence caused by motion of the coil in operation. To mitigate the loss of ferrofluid during use it has been proposed that a so-called “bucking” magnet be positioned to catch droplets of ferrofluid sprayed from the gap.

An object of the invention is to address the problem of providing a suspension system which ensures that the voice coil is accurately positioned and particularly, although not necessarily exclusively, to provide a system which is suitable for implementation in high excursion relatively small (as hereinafter defined) loudspeaker drive units.

In a first aspect of the invention there is provided a loudspeaker drive unit including a moving coil motor including a magnet assembly with primary and secondary gaps defined thereby, a voice coil assembly axially movable with respect to said primary and secondary gaps, said voice coil assembly including a former and an electromagnetic coil mounted on the former at the location of the primary gap and wherein the former is positioned with respect to the secondary gap by the influence of ferrofluid located in said secondary gap.

According to the invention in a further aspect, there is provided a high excursion moving coil loudspeaker drive unit having a small diaphragm, characterised by a magnet assembly defining a gap having a primary gap region and a secondary gap region, a voice coil assembly arranged for axial movement in the gap, the voice coil comprising a tubular former having opposed first and second axial ends and having a first end portion adapted to be drivingly coupled to a loudspeaker diaphragm, an electromagnetic coil wound on the former near to the second end of the former, the arrangement being such that the coil is located in the gap adjacent to the primary region and that the intermediate portion of the former is disposed in the gap adjacent to the secondary region, and characterised by ferrofluid in the secondary gap and suspending the former in the gap for axial movement therein.

In a yet further aspect of the invention there is provided loudspeaker drive unit having a small diaphragm, characterised by a high excursion moving coil motor having a magnet assembly defining a gap having a primary gap region and a secondary gap region, and a voice coil assembly arranged for axial movement in the gap, the voice coil assembly comprising a tubular former having opposed first and second axial ends, said first end portion adapted to be drivingly coupled to the loudspeaker diaphragm, an electromagnetic coil wound on the former near to the second end of the former, and an intermediate portion disposed between the coil and the first end of the former, the arrangement being such that the coil is located in the gap adjacent to the primary region and that the intermediate portion of the former is disposed in the gap adjacent to the secondary region, and characterised by ferrofluid provided in at least the secondary gap which acts to suspend the former in the gap for axial movement therein.

A small diaphragm loudspeaker drive unit in the context of the present application is one in which, in the case of a circular diaphragm, has a maximum diameter of not substantially more than 152.4 mm and is preferably no more than 127 mm in diameter. In the case of an elliptical or rectangular diaphragm, a small drive unit is one have a maximum width of not substantially more than 127 mm.

It is conventional for the voice coil assembly to comprise a former that is circular in cross-section, and in this case the gap in the magnet assembly is annular in shape. It is however possible to make the voice coil former to be of other cross-sectional shapes, e.g. of so-called “race track” shape that comprises a parallel pair of straight portions joined together by semi-circular portions.

Ferrofluid may also be present in the primary gap.

The drive unit may be intended for full range operation and may operate in piston mode at low frequencies and in bending wave mode at high frequencies. Alternatively, the drive unit may be intended for bass frequencies only.

The diaphragm may be circular or may be elliptical or substantially rectangular in shape. The diaphragm may be of high aspect ratio. The diaphragm may be conical or otherwise dished or flat.

The invention is diagrammatically illustrated, by way of example, in the accompanying drawings, in which:

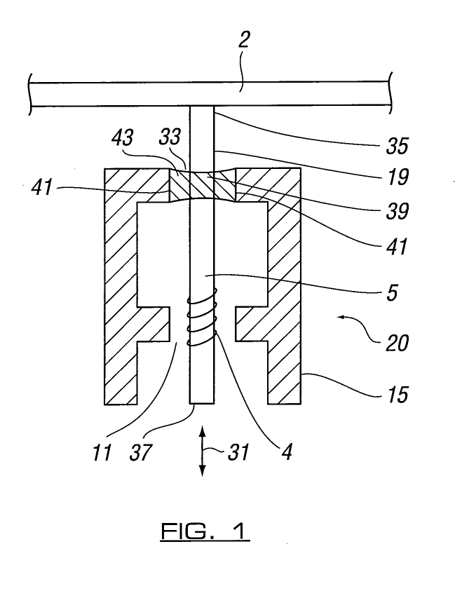

FIG. 1 illustrates schematically an embodiment of the invention;

FIG. 2 is a cross-sectional side view of a loudspeaker drive unit; in accordance with one embodiment of the invention;

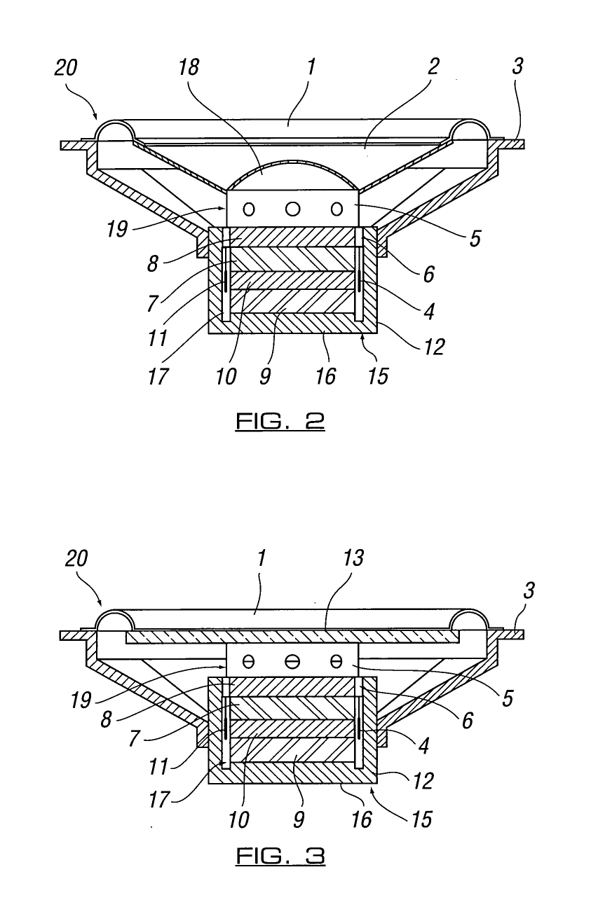

FIG. 3 is a cross-sectional side view of a further embodiment of a loudspeaker drive unit, in accordance with the invention;

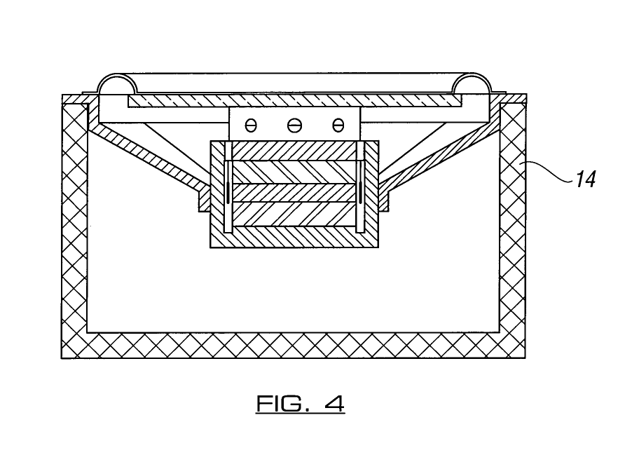

FIG. 4 is a cross-sectional side view of a loudspeaker incorporating the drive unit of FIG. 3.

Referring firstly to FIG. 1 there is illustrated, schematically, the features of the invention in accordance with one embodiment. The drive unit 20 includes a diaphragm 2 connected to be driven by a voice coil assembly 19 mounted to be axially movable, as indicated by arrow 31, with respect to a magnet assembly or system 15. The magnet assembly defines a primary gap 11 and a secondary gap 33.

The voice coil assembly 19 includes a former 5 which has an end 35 connected to drive the diaphragm 2 and an opposing end 37. Towards the end 37 there is mounted the voice coil 4 and this is located in the primary gap 11. A further portion 39 of the former 19 is located in the secondary gap 33 and is located with respect to the side walls 41 of the gap by the provision of ferrofluid 43 which acts to maintain the former in a substantially constant spaced position from the side walls 41 while ensuring the axial movement 31 of the former 5 can be performed.

Referring now to FIG. 2 of the drawings, there is shown a loudspeaker drive unit 20 made in accordance with the present invention and comprising a chassis or basket 3 which rigidly supports a magnet system 15 comprising a generally tubular cup 12 having one closed end 16 and in which is rigidly mounted a concentric stack formed by a disc-like magnet 9, a disc-like primary or inner pole piece 10, a secondary disc-like magnet 7 and a secondary or outer disc-like pole piece 8. The primary magnet 9 and secondary magnet 7 are both axially magnetised and are arranged with their fields in opposition. The stack of magnets 7,9 and the pole pieces 8,10 are positioned concentrically in the cup 12 and are of smaller diameter than the interior of the cup to form a small annular gap 17 between the interior curved wall of the cup and the magnet/pole piece stack.

The chassis 3 resiliently supports a conical loudspeaker diaphragm 2 at its outer periphery by means of a flexible roll surround 1 to permit the diaphragm to move axially. The inner periphery of the conical diaphragm is closed by a concentric dome which thus forms part of the radiating surface of the diaphragm.

A voice coil assembly 19 comprising a tubular former 5 on which is wound a coil 4 is mounted in the gap 17 so as to be axially reciprocal therein and with its coil 4 opposite to the primary pole piece 10. One end of the coil former 5 is fixed to the diaphragm so that it drives the diaphragm in response to an alternating electrical signal fed to the coil.

A second suspension is formed by filling an intermediate portion 6 of the annular gap adjacent to the secondary pole piece with ferrofluid so that the voice coil former is smoothly guided in the annular gap. This portion of the gap can be referred-to as the secondary gap, as distinct from the primary gap 11 in the vicinity of the coil 4.

In FIG. 3 there is shown a second embodiment of loudspeaker drive unit in accordance with the invention. In this embodiment, the drive unit is very similar to that shown in FIG. 2 with the exception that here the diaphragm 13 is flat. FIG. 4 shows a loudspeaker drive unit of the kind shown in FIG. 3 mounted in a box-like enclosure 14 to form a loudspeaker.

Advantages of the embodiments of loudspeaker drive unit motor described above with reference to the drawings, include that the absence of the spider coupling to the diaphragm results in improved frequency response smoothness and a reduced moving mass. This can be beneficial when used in the full range drive units.

An improved sound quality can be achieved due to better acoustic flow from the rear of the driver. High linearity can also be achieved thus allowing high excursions and high efficiency due to the dual gap motor which is created. Good voice coil lateral (x,y) stability is achieved as well as a reduced tendency for ferrofluid to be lost from the secondary gap as it is located away from the turbulence caused by the movement of the voice coil in the primary gap. A longer life can thus be achieved for the ferrofluid in the secondary gap due to its location away from the turbulence and also its spacing from the heat generated by the coil. In terms of the audio which is generated improved performance is achieved especially with respect to bass performance of small area, low footprint drive units in particular, and high excursion capability is achieved for drive unit applications in limited space, such as in TV, multimedia and automotive applications.

1. A loudspeaker drive unit including a moving coil motor including a magnet assembly with primary and secondary gaps defined thereby, a voice coil assembly axially movable with respect to said primary and secondary gaps, said voice coil assembly including a former and an electromagnetic coil mounted on the former at the location of the primary gap and wherein the former is positioned with respect to the secondary gap by the influence of ferrofluid located in said secondary gap.

2. A drive unit according to claim 1 wherein the voice coil assembly is solely located by the influence of the ferrofluid in the secondary gap.

3. A drive unit according to claim 1 wherein ferrofluid is provided in the primary gap.

4. A loudspeaker drive unit according to claim 1 capable of a substantially full range of operation.

5. A loudspeaker drive unit according to claim 4 adapted to operate in piston mode at low frequencies and in bending wave mode at high frequencies.

6. A loudspeaker drive unit according to claim 1 wherein the drive unit includes a small diaphragm.

7. A loudspeaker drive unit according to claim 6 wherein the diaphragm of the drive unit is substantially flat.

8. A loudspeaker drive unit according to claim 1 wherein the unit has a diaphragm with an aspect ratio of at least 4:1.

9. A loudspeaker drive unit according to claim 1 wherein a plurality of voice coil assemblies are provided to drive a diaphragm of the drive unit.

10. A loudspeaker drive unit according to claim 9 wherein the voice coil assemblies are spaced apart along the length of an elongate shaped diaphragm.

11. A loudspeaker drive unit according to claim 1 wherein the unit is adapted to generate bass frequencies.

12. A loudspeaker drive unit according to claim 1 wherein the former is tubular in shape.

13. A drive unit according to claim 1 wherein the drive unit includes a substantially circular diaphragm with a maximum diameter of less than 152.4 mm.

14. A drive unit according to claim 1 wherein the drive unit includes a diaphragm which is elongate in shape and has a maximum width of less than 127 mm.

15. A drive unit according to claim 1 wherein the moving coil motor is a high excursion moving coil motor.

16. A drive unit according to claim 1 wherein a first end of the former is located to drive a diaphragm of the drive unit, and the voice coil is located towards the second end of the former, with at least part of the portion of the former between the voice coil and the said first end located in the said secondary gap.

17. A drive unit according to claim 1 wherein the position of the former with respect to the side walls of the secondary gap is influenced by the ferrofluid present in the secondary gap.

18. A drive unit according to claim 17 wherein the spacing of the former from the side walls of the secondary gap is maintained substantially constant by the influence of the ferro fluid.

19. A drive unit according to claim 17 wherein the former is substantially centrally positioned in the secondary gap by the influence of the ferrofluid.

20. A loudspeaker drive unit having a diaphragm and a moving coil motor having a magnet assembly with a primary gap region and a secondary gap region, and a voice coil assembly arranged for axial movement in the said gaps, the voice coil assembly including a former and an electromagnetic coil wound on the former such that the coil is located in or adjacent to the primary gap and another portion of the former is disposed in the secondary gap and wherein ferrofluid is provided in at least the secondary gap to act to suspend the former and hence the voice coil assembly in a substantially constant position with respect to the spacing from the side walls of said gaps while allowing axial movement of the voice coil assembly with respect to the magnet assembly to drive the diaphragm.

21. A loudspeaker drive unit having a small diaphragm, characterised by a high excursion moving coil motor having a magnet assembly defining a gap having a primary gap region and a secondary gap region, and a voice coil assembly arranged for axial movement in the gap, the voice coil assembly comprising a tubular former having opposed first and second axial ends, said first end portion adapted to be drivingly coupled to the loudspeaker diaphragm, an electromagnetic coil wound on the former near to the second end of the former, and an intermediate portion disposed between the coil and the first end of the former, the arrangement being such that the coil is located in the gap adjacent to the primary region and that the intermediate portion of the former is disposed in the gap adjacent to the secondary region, and characterised by ferrofluid provided in at least the secondary gap which acts to suspend the former in the gap for axial movement therein.

22. A loudspeaker including a baffle and a loudspeaker drive unit as claimed in claim 1 mounted on the baffle.
